(19) United States
(12) Patent Application Publication
(10) Pub. No.: US 2006/0231207 A1
(43) Pub. Date: Oct. 19, 2006

(54) System and method for surface treatment

(76) Inventors: Douglas A. Rebinsky, Peoria, IL (US); Michael L. Johnson, Henry, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/389,317

(22) Filed: Mar. 27, 2006

Related U.S. Application Data
(60) Provisional application No. 60/666,578, filed on Mar. 31, 2005.

(51) Int. Cl. C23F 1/00; B08B 6/00; B44C 1/22; H01J 7/24

(52) U.S. Cl. 156/345.41; 134/1.1; 216/69; 315/111.21

(57) ABSTRACT

A surface treatment system may include a microwave chamber and an insulating cavity located within the microwave chamber. The insulating cavity may be configured to receive an object. The system also may include a supply of solvent gas in selective fluid communication with the insulating cavity and a magnetron configured to emit microwave radiation. The system may further include a waveguide operatively connected to the microwave chamber and the magnetron. The waveguide may be configured to direct microwave radiation into the insulating cavity to form a solvent gas plasma from the solvent gas. The solvent gas plasma may be configured to dissolve surface contamination on the object.

This application claims the benefit of prior U.S. Provisional Patent Application No. 60/666,578, filed on Mar. 31, 2005.

### TECHNICAL FIELD

The present disclosure relates to a system and method for surface treating an object and, more particularly, to a system and method for surface treating an object using microwave radiation.

### BACKGROUND

Work machines often include a variety of parts, such as, for example, gears, bearings, plates, crankshafts, cylinder blocks, fuel system components, and other parts that cooperate to perform a particular function. Surface contamination may build on these parts before and after assembly into the work machine, which may affect performance, life of the part, and/or value of the work machine. These parts may undergo a surface treatment to remove contamination prior to assembly, periodically during operation of the work machine, or during remanufacture of the work machine in preparation for reuse or resale.

Clean part surfaces may be crucial to producing a uniform, defect-free coating that meets specifications. In addition, contamination may make coated surfaces appear rough and uneven, which may be undesirable to customers. Contamination may also cause more serious localized defects by interfering with the bonding between the coat and base metal, which may result in premature failure.

The removal of surface contamination typically requires the use of chemicals, such as, for example, solvents, emulsions, and water based cleaners (acid, neutral or alkaline). The techniques used may include abrasive blasting, acid washes, and complex multistage cleaning processes, which may require both sustained heat and large areas of floor space in a cleaning or remanufacturing facility. While these systems and processes may be capable of removing the surface contamination, they may be inefficient, costly, and environmentally unfriendly.

In addition to cleaning, it may also be desirable to perform other surface treatments on the parts of the work machine. One system that has been developed to surface treat parts is described in the article titled, “Emerging Microwave Technology,” hereinafter referred to as the “EMT article.” Heat Treating Progress, 4; ASM International, 2004. The EMT article describes a system that uses microwave radiation and plasma for heat treating and coating metal parts. The microwave radiation heats a plasma, which in turn transfers the heat to the metal part within the plasma. The plasma may be used for carburization, sintering, or brazing of the metal part.

While the system from the EMT article may be effective for heat treating metal parts, it may be ineffective or unsuitable for cleaning surface contamination. For example, a metal part may have unique physical characteristics and features, and so certain portions of the part's outer surface may require more or less cleaning than other areas. Because the system in the EMT article may surround the entire metal part evenly with plasma instead of directing a flow of plasma onto specific portions of the metal part's outer surface, it may be unable to focus on portions of the metal part that may have more surface contamination.

The present disclosure is directed towards overcoming one or more of the problems set forth above.

### SUMMARY OF THE INVENTION

In one aspect, the present disclosure may be directed to a surface treatment system. The system may include a microwave chamber and an insulating cavity located within the microwave chamber. The insulating cavity may be configured to receive an object. The system may also include a supply of solvent gas in selective fluid communication with the insulating cavity. A magnetron may be configured to emit microwave radiation, and a waveguide may be operatively connected to the microwave chamber and the magnetron. The waveguide may be configured to direct the microwave radiation into the insulating cavity to form a solvent gas plasma from the solvent gas. The solvent gas plasma may be configured to dissolve surface contamination on the object.

Another aspect of the present disclosure may be directed to a surface treatment system. The system may include a microwave chamber configured to receive an object and a plasma chamber operatively connected to the microwave chamber in selective fluid communication with a supply of solvent gas. The system may further include a magnetron configured to emit microwave radiation and a waveguide operatively connected to the magnetron. The waveguide may be configured to direct the microwave radiation into the plasma chamber to form a solvent gas plasma within the plasma chamber. The solvent gas plasma may be configured to dissolve surface contamination on the object. A movable nozzle device may fluidly communicate with the microwave chamber. The movable nozzle device may be configured to direct the solvent gas plasma from the plasma chamber into the microwave chamber toward the object.

Yet another aspect of the present disclosure may be directed to a method of surface treating. The method may include supplying a solvent gas in a region adjacent to a surface of an object and directing microwave radiation into the solvent gas to excite the solvent gas into a solvent gas plasma. The solvent gas plasma may be configured to dissolve surface contamination on the object.

Yet another aspect of the present disclosure may be directed to a method of surface treating. The method may include placing an object within a microwave chamber, supplying a solvent gas in a plasma chamber, and directing microwave radiation into the plasma chamber to excite the solvent gas to form a solvent gas plasma. The method may also include directing the solvent gas plasma from the plasma chamber toward a surface of the object within the microwave chamber. The solvent gas plasma may be configured to dissolve surface contamination on the object.

### BRIEF DESCRIPTION OF THE DRAWINGS

FIG. 1 is a diagrammatic perspective view illustration of an exemplary disclosed surface treatment system.

FIG. 2 is a diagrammatic perspective view illustration of another exemplary disclosed surface treatment system.

FIG. 3 is a diagrammatic perspective view illustration of another exemplary disclosed surface treatment system.

FIG. 4 is a diagrammatic perspective view illustration of another exemplary disclosed surface treatment system.

### DETAILED DESCRIPTION

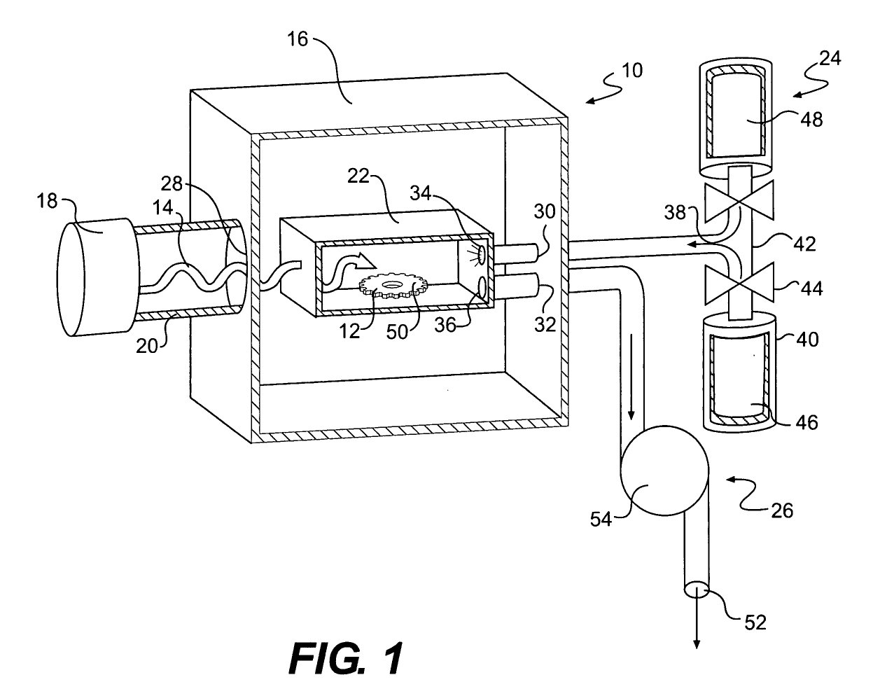

FIG. 1 is a diagrammatic perspective view of an exemplary disclosed surface treatment system 10. Surface treatment system 10 may clean, heat, and/or treat an object 12 using microwave radiation 14. Surface treatment system 10 may include, for example, a microwave chamber 16, a microwave source 18, a waveguide 20, an insulating cavity 22, a gas supply assembly 24, and an exhaust assembly 26.

Microwave chamber 16 may be configured to house various components of system 10 and may define boundaries within which the surface treatment process may be carried out. Microwave chamber 16 may be reflective to minimize microwave leakage into the surrounding environment and to minimize energy loss. At least one surface of microwave chamber 16 may include an aperture 28 allowing microwave radiation 14 to enter microwave chamber 16 from microwave source 18. Other surfaces of microwave chamber 16 may include an inlet 30 and an outlet 32 to allow elements external to microwave chamber 16 to fluidly communicate with the inside of microwave chamber 16. The material used to construct microwave chamber 16 may include a metal. In one embodiment, microwave chamber 16 may be constructed of stainless steel, which may be resistant to staining solutions and solvents. Microwave chamber 16 may be configured as a rectangular housing, cylindrical barrel, or any other suitable shape.

Microwave source 18 may generate microwave radiation 14, and may do so at one or more predetermined frequencies. Some examples of microwave frequencies that may be utilized include 915 MHz, 2.45 GHz, or 5.8 GHz. Preferably, radiation having any frequency less than approximately 333 GHz may be used. Microwave source 18 may include a magnetron, which may include a diode vacuum tube in which the flow of electrons from a central cathode to a cylindrical anode may be controlled by crossed magnetic and electric fields. Additionally or alternatively, the microwave source 18 may include a plurality of magnetrons used together in combination.

Waveguide 20 may direct microwave radiation 14 from microwave source 18 into microwave chamber 16. Waveguide 20 may be in a location external to microwave chamber 16 with one end operatively coupled to aperture 28 in the surface of the microwave chamber 16. The other end of waveguide 20 may be operably connected to microwave source 18. Waveguide 20 may include a hollow metal conductor. Examples of metals which may be used in waveguide 20 may include, aluminum, brass, and copper. Alternatively, waveguide 20 may include a flexible body which may include neoprene rubber and silicone. Waveguide 20 may have any suitable cross-sectional shape, and may be straight, bent, or twisted along an axis.

Insulating cavity 22 may provide a sealed area that contains a gas 38, and may have a surface for holding an object 12. Insulating cavity 22 may be constructed of a material which may be capable of withstanding heat and may also be substantially transparent to microwave radiation 14. For example, insulating cavity 22 may be made of ceramic, quartz, polycarbonate, glass, or any other suitable material. Insulating cavity 22 may be placed within microwave chamber 16 and may be mounted in a central portion of microwave chamber 16. Furthermore, insulating cavity 22 may include an inlet 34 and an outlet 36 to selectively allow fluid communication between insulating cavity 22 and areas outside of insulating cavity 22.

Gas supply assembly 24 may be in fluid communication with insulating cavity 22 and may control, supply, and direct the flow of gas 38. Gas supply assembly 24 may include several components, such as, for example, a gas source 40, a gas line 42, and a valve device 44. It is contemplated that gas supply assembly 24 may include any number of gas sources 40, gas lines 42, and/or valve devices 44.

Gas 38 provided by gas supply assembly 24 may include a solvent gas 46 and/or a surface treatment gas 48. It is contemplated that solvent gas 46 may be used to clean surface contamination from the surface of object 12. Cleaning may be accomplished by several mechanisms, including, for example, burning off the surface contamination, dissolving the surface contamination using solvent gas 46, and/or ejecting the surface contamination off the surface via momentum transfer, or any other suitable process. Solvent gas 46 may include, for example, argon, nitrogen, xenon, krypton, and/or other suitable gases and compounds. The exact formulation of solvent gas 46 may vary depending upon the properties of the surface contamination. For example, solvent gas 46 may be selected to assure that the surface contamination may be at least partially soluble therein, so that solvent gas 46 may dissolve the surface contamination, with the solvent gas 46 and surface contamination combining to form a solution during the operation of surface treatment system 10.

Surface treatment gas 48 may be used to surface treat and/or deposit a coating 50 on object 12, and may include, for example, argon, nitrogen, xenon, krypton, and/or other suitable gases and compounds. The coating process may include releasing atoms from one surface by, for example, evaporation, and deposition of the released atoms onto a nearby target surface (sputtering). For example, surface treatment gas 48 may be used to evaporate a solid metal rod, and the evaporated particles of the rod may be deposited as a coating on another surface. Coating may also occur through a chemical reaction of gases in insulating cavity 22 producing components which deposit on and adhere to surface of object 12. Coating 50 may include hard-material coatings, such as carbides, nitrides, or oxides.

Solvent gas 46 and/or surface treatment gas 48 may be microwave-absorbing, and when excited, may provide a plasma. Plasma may be defined as an electrically neutral, highly ionized gas composed of ions, electrons, and neutral particles. In addition to having microwave absorbing characteristics, solvent gas 46 and/or surface treatment gas 48 may also be selected so as to minimize arcing when object 12 may be subjected to microwave radiation 14.

Gas source 40 may store a volume of solvent gas 46 or surface treatment gas 48, which can be selectively directed into insulating cavity 22. Gas source 40 may include a gas cylinder, gas cabinet, or any other suitable gas storage device, and may be constructed using aluminum, stainless steel, bronze, or any other suitable material. Gas source 40 may also be nickel-plated to offer corrosion resistance when using reactive gases. Components such as pressure regulators, air compressors, quality monitors, driers, manifolds, and/or pumps may also be operatively connected to gas source 40 to help ensure proper function.

Gas line 42 and valve device 44 may provide a path for fluid communication between gas source 40 and insulating cavity 22. Gas line 42 and valve device 44 may be used to control the rate of flow, adjust the pressure in the insulating cavity 22, and/or block gas 38 from entering insulating cavity 22. Any number of gas lines 42 and valve devices 44 may be used. If a plurality of gas lines 42 and valve devices 44 are employed, they may provide multiple paths for fluid communication between one or more gas sources 40 and insulating cavity 22. Where more than one valve device 44 may be employed, each may be independently and selectively adjusted between open and closed positions either by manual, pneumatic, or electronic control, in order to regulate the flow of gas toward insulating cavity 22. It is contemplated that gas line 42 may include flexible tubing, hoses, pipes, or any other device for guiding fluid flow. Valve device 44 may include, for example, solenoid actuated valves that may be operated automatically. Valve device 44 may also include pneumatically or manually operated gate valves.

Exhaust assembly 26 may include an outlet 52 for gas 38 to exit system 10. Exhaust assembly 26 may include a pump 54 in fluid communication with insulating cavity 22. Pump 54 may include any suitable mechanical device that moves fluid or gas by pressure or suction, including, for example, fans and vacuum pumps. Gas 38 may be discharged into the atmosphere, or alternatively, into a gas cylinder, gas cabinet, or any other suitable gas storage device for recycling or disposal. During operation of system 10, exhaust assembly 26 may channel used gas (gas that has been saturated with the surface contamination) out from within insulating cavity 22, so that fresh gas 38 (unsaturated by surface contamination) may flow towards object 12 to help ensure that the surface contamination may be readily dissolved.

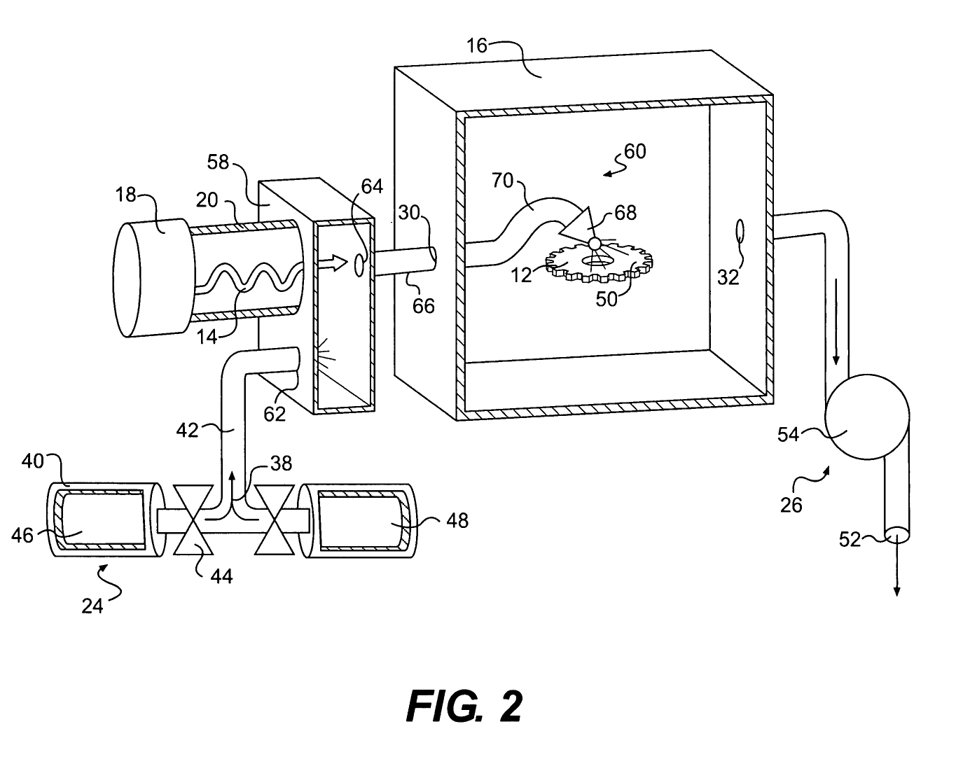

FIG. 2 is a diagrammatic perspective view illustration of another exemplary disclosed surface treatment system 56. This embodiment may incorporate some of the elements from the previous embodiment, such as microwave chamber 16, microwave source 18, gas supply assembly 24, and exhaust assembly 26. This embodiment may include a plasma chamber 58 and at least one moveable nozzle device 60.

Plasma chamber 58 may provide an enclosed area where gas 38 may be excited into plasma prior to entering microwave chamber 16. Plasma chamber 58 may be operably connected to waveguide 20, thus allowing microwave radiation 14 to enter plasma chamber 58 and excite gas 38. Plasma chamber 58 may have an inlet 62 to allow gas 38 into plasma chamber 58 and an outlet 64 to allow the plasma to exit plasma chamber 58. Upon exiting plasma chamber 58, plasma may be directed towards microwave chamber 16. The walls of the plasma chamber 58 may reflect and/or absorb the microwave radiation to prevent it from leaking out into the environment.

Moveable nozzle device 60 may direct the plasma from plasma chamber 58 into microwave chamber 16 and towards object 12. Moveable nozzle device 60 may be manually or automatically positioned to aim the flow of plasma onto specific portions or surfaces of object 12. This positioning may create a focused, directed flow of plasma. Moveable nozzle device 60 may include a selectively adjustable plasma line 66 and one or more nozzles 68. At least a portion of plasma line 66 may be a flexible hose portion 70, which may allow nozzle 68 to be selectively positioned with respect to object 12.

Nozzle 68 may direct a flow of fluid, and may include a projecting vent or a short tube with a taper or constriction. Divergent nozzles (e.g., expanding from a smaller diameter to a larger one), convergent nozzles (e.g., narrowing down from a wide diameter to a smaller diameter in the direction of the flow), or combination convergent-divergent nozzles (e.g., having convergent and divergent sections) may be used. Nozzle 68 may direct the flow of the plasma onto object 12, or more specifically, onto targeted portions of object 12. Nozzle 68 may be made of refractory metal, refractory-metal carbide, graphite, ceramic, cermets, fiber-reinforced plastic, or any other suitable material.

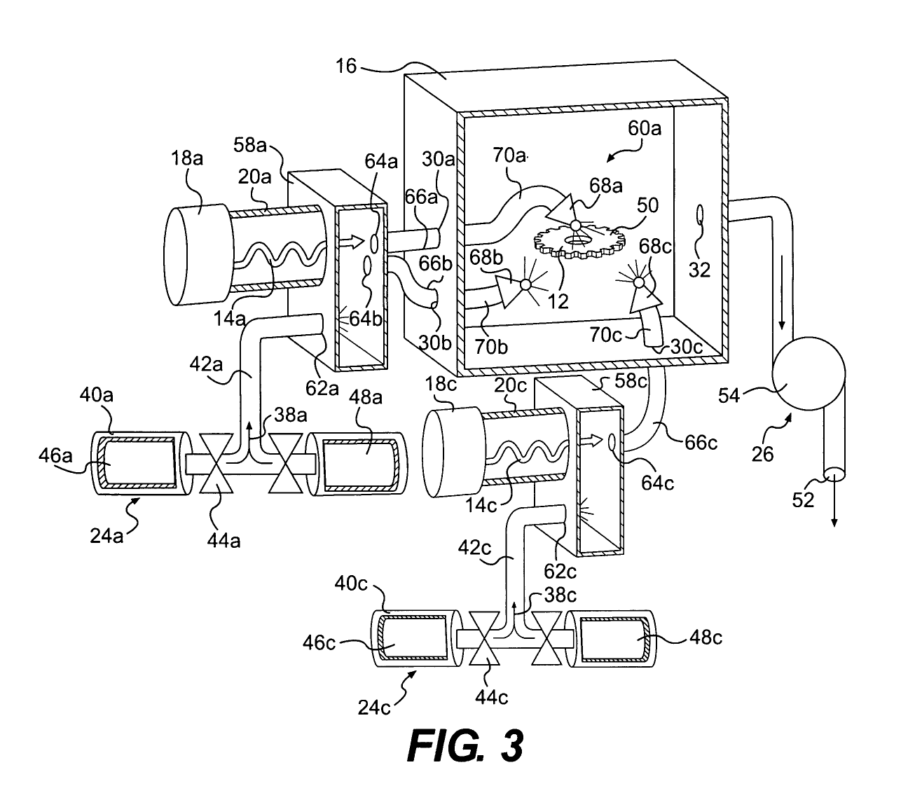

Although a single nozzle device 60 and nozzle 68 is shown in FIG. 2, it should be understood that multiple nozzle devices may extend into microwave chamber 16 at various locations, in order to provide focused, directed flows of plasma onto object 12. For example, in FIG. 3, plasma chamber 58 may include outlets 64a and 64b, wherein each of outlets 64a and 64b may include an associated flexible hose portion 70a and 70b and nozzle device 68a and 68b that may extend into microwave chamber 16. Additionally or alternatively, multiple microwave sources 18a and 18c, gas supply assemblies 24a and 24c, plasma chambers 58a and 58c, flexible hose portions 70a and 70c, and moveable nozzle devices 60a and 60c, may be included.

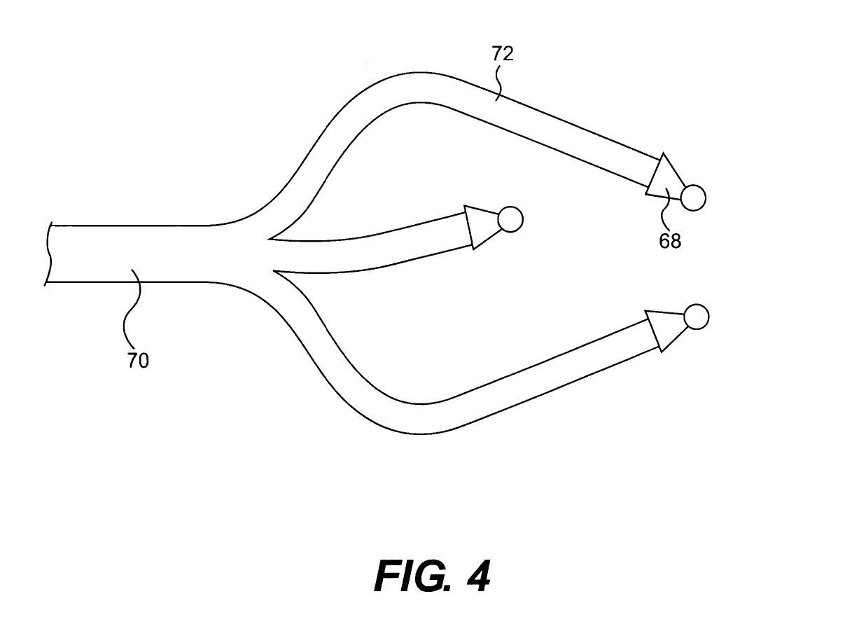

It is also contemplated that flexible hose portion 70 may split into one or more flexible tube portions 72, as shown in FIG. 4. Each flexible tube portion 70 may terminate with its own nozzle device 68, and thus, may direct plasma onto object 12 from its own individual location. This arrangement may help to ensure that substantially all of the surfaces of object 12 may be reached by plasma.

### INDUSTRIAL APPLICABILITY

The disclosed system 10 may be used for surface treatment of various types of metal components. System 10 may be efficient, may decrease processing costs, and may also improve quality.

System 10 may decrease energy costs because of its ability to switch on and off between adjacent cycles. For example, system 10 may use electromagnetic radiation so that immediately after microwave source 18 is switched on, microwave radiation 14 may be applied. Immediately after microwave source 18 is switched off, the heating process may cease. Thus, an operator may efficiently clean and/or surface treat an object 12 without waiting for system 10 to pre-heat or cool down to a certain temperature. Therefore, long periods of sustained heat may be avoided. Maintaining sustained high temperatures may require significant amounts of energy and so decreasing the amount of energy used may result in cost savings. System 10 may also improve efficiency by performing cleaning, heat treating, and/or coating with minimal downtime between cycles. Furthermore, each of the steps may be repeated as desired. For example, system 10 may clean object 12, and afterwards, system 10 may deposit a coating 50 on object 12. Subsequent to performing coating, system 10 may be used to heat treat object 12 to give the coated component desired metallurgical properties. Additionally or alternatively, heat treatment may occur prior to coating. System 10 may provide the benefit of allowing any series of these steps to be carried out in a single apparatus.

The present system 10 may also energize the surface of object 12 by, for example, heating the surface, to assist in the application of coating 50. While conventional surface finishing methods may involve heating the entire object 12, system 10 may add energy and material onto the surface only, and in so doing, surface properties may be modified with minimal change to the underlying structure of object 12. Also, by performing coating immediately after cleaning, system 10 may take advantage of the fact that object 12 may already be at a high temperature, which may assist in bonding or adhering coating 50 to the surface of object 12. Furthermore, by minimizing the time between cleaning and coating, the amount of scale and oxidation that may build on the surface of object 12 may also be minimized.

The present system 10 may minimize the occurrence of defects caused by surface contamination, such as grime, paint, oil, carbon, which may make the appearance of coated surfaces rough and uneven or interfere with the bonding between a coating and a substrate. Such defects may cause metal parts to exhibit poor mechanical and/or metallurgical properties, such as, for example, decreased wear resistance and/or premature failure. System 10 may avoid such defects by cleaning the surface of object 12 prior to heat treating and/or coating, which may improve the appearance of object 12 while also aiding bonding between coating 50 and the surface of object 12.

Additionally, the present system 56 in the second embodiment may create a focused flow of plasma onto object 12. Because object 12 may have unique physical characteristics and features, certain portions of its outer surface may require more or less cleaning and treating than other areas. Rather than just surrounding the entire object 12 with plasma so that every surface may be uniformly subjected to treatment, system 56 may provide a directed flow of plasma only onto specific surfaces of object 12. Thus, system 56 may provide focused cleaning and/or directed coating on specific surfaces of object 12. This may allow an operator to exercise greater control over the cleaning and treating of the parts, which may result in improved cleaning results, less waste of time and resources, and greater efficiency.

It will be apparent to those skilled in the art that various modifications and variations can be made in the disclosed surface treatment systems and methods without departing from the scope of the disclosure. Additionally, other embodiments of the disclosed systems will be apparent to those skilled in the art from consideration of the specification. It is intended that the specification and examples be considered as exemplary only, with a true scope of the disclosure being indicated by the following claims and their equivalents.

What is claimed is:

1. A surface treatment system, comprising:
a microwave chamber;
an insulating cavity located within the microwave chamber and configured to receive an object;
a supply of solvent gas in selective fluid communication with the insulating cavity;
a magnetron configured to emit microwave radiation; and
a waveguide operatively connected to the microwave chamber and the magnetron and configured to direct the microwave radiation into the insulating cavity to form a solvent gas plasma from the solvent gas, the solvent gas plasma being configured to dissolve surface contamination on the object.

2. The system of claim 1, further including a supply of surface treatment gas in selective fluid communication with the insulating cavity, wherein the direction of the microwave radiation into the insulating cavity forms a surface treatment gas plasma from the surface treatment gas.

3. The system of claim 2, wherein the surface treatment gas plasma is configured for at least one of heat treating and depositing a coating on the object.

4. The system of claim 1, wherein the insulating cavity includes a heat-resistant material substantially transparent to microwave radiation.

5. A surface treatment system, comprising:
a microwave chamber configured to receive an object;
a plasma chamber operatively connected to the microwave chamber;
a supply of solvent gas in selective fluid communication with the plasma chamber;
a magnetron configured to emit microwave radiation;
a waveguide operatively connected to the magnetron and configured to direct the microwave radiation into the plasma chamber to form a solvent gas plasma within the plasma chamber, the solvent gas plasma configured to dissolve surface contamination on the object; and
a movable nozzle device in fluid communication with the microwave chamber, the movable nozzle device being configured to direct the solvent gas plasma from the plasma chamber into the microwave chamber toward the object.

6. The system of claim 5, further including a supply of surface treatment gas in selective communication with the plasma chamber, wherein the microwave radiation forms a surface treatment gas plasma from the surface treatment gas.

7. The system of claim 6, wherein the surface treatment gas plasma is configured for at least one of heat treating and depositing a coating on the object.

8. A method of surface treating, comprising:
supplying a solvent gas in a region adjacent to a surface of an object; and
directing microwave radiation into the solvent gas to excite the solvent gas to form a solvent gas plasma, the solvent gas plasma being configured to dissolve surface contamination on the object.

9. The method of claim 8, further including supplying a surface treatment gas in the region adjacent to the surface of the component and directing microwave radiation into the surface treatment gas to excite the surface treatment gas to form a surface treatment gas plasma.

10. The method of claim 9, further including supplying the surface treatment gas simultaneously with the solvent gas.

11. The method of claim 9, further including supplying the surface treatment gas after supplying the solvent gas.

12. The method of claim 9, further including at least one of heat treating and depositing a coating on the surface of the object using the surface treatment gas.

13. A method of surface treating, comprising:
placing an object within a microwave chamber;
supplying a solvent gas in a plasma chamber;
directing microwave radiation into the plasma chamber to excite the solvent gas to form a solvent gas plasma; and
directing the solvent gas plasma from the plasma chamber toward a surface of the object within the microwave chamber, the solvent gas plasma being configured to dissolve surface contamination on the object.

14. The method of claim 13, further including supplying a surface treatment gas in the plasma chamber, directing microwave radiation into the plasma chamber to excite the surface treatment gas to form a surface treatment gas plasma, and directing the surface treatment gas plasma from the plasma chamber toward the surface of the object.

15. The method of claim 14, further including supplying the surface treatment gas simultaneously with the solvent gas.

16. The method of claim 14, further including supplying the surface treatment gas after supplying the solvent gas.

17. The method of claim 14, further including at least one of heat treating and depositing a coating on the surface of the object using the surface treatment gas.

18. The method of claim 14, further including passing the surface treatment gas plasma through a movable nozzle to create a directed flow.

19. The method of claim 13, further including passing the solvent gas plasma through a movable nozzle to create a directed flow.

20. The method of claim 13, further including converting the solvent gas into a reactive state to dissolve surface contamination.
